(19) United States
(12) Patent Application Publication
(10) Pub. No.: US 2020/0009922 A1
(43) Pub. Date: Jan. 9, 2020

(54) TIRE-WHEEL ASSEMBLY

(71) Applicant: HONDA MOTOR CO., LTD., Tokyo (JP)

(72) Inventors: Yusuke OSAWA, Wako-shi (JP); Toshinobu SAITO, Wako-shi (JP); Youichi KAMIYAMA, Wako-shi (JP)

(21) Appl. No.: 16/460,721

(22) Filed: Jul. 2, 2019

(30) Foreign Application Priority Data
Jul. 6, 2018 (JP) 2018-129229

(51) Int. Cl. B60C 19/00

(52) U.S. Cl. CPC B60C 19/002

(57) ABSTRACT

A tire-wheel assembly includes: a wheel having a pair of bead seats and a well portion; a tire having a pair of tire beads seated on the pair of bead seats; a lid body having two edge portions located opposite each other in a wheel width direction; and a sub-air chamber member disposed on the lid body. Each of the two edge portions is sandwiched between corresponding one of the pair of bead seats and corresponding one of the pair of tire beads so that the lid body is arranged above the well portion.

### CROSS-REFERENCE TO RELATED APPLICATIONS

The present application claims priority under 35 U.S.C. § 119 to Japanese Patent Application No. 2018-129229, filed Jul. 6, 2018, the contents of which are hereby incorporated by reference in their entirety.

### BACKGROUND OF THE INVENTION

### 1. Field of the Invention

The present invention relates to a tire-wheel assembly.

### 2. Description of the Related Art

There have been known vehicle wheels including a Helmholtz resonator on an outer circumferential surface of a well portion of a rim (e.g., see Japanese Patent Application Publication No. 2012-45971). The vehicle wheel described in Japanese Patent Application Publication No. 2012-45971 has vertical walls formed thereon extending in a wheel circumferential direction on an outer circumferential surface of the well portion and has a Helmholtz resonator locked in groove portions formed on the vertical walls. With this structure of the vehicle wheel, the Helmholtz resonator can be attached to the rim easily.

### SUMMARY OF THE INVENTION

However, commercially sold conventional vehicle wheels (e.g., see Japanese Patent Application Publication No. 2012-45971) cannot be used as is because the groove portions need to be formed on the vertical walls, and thus the production cost of the vehicle wheels is increased. In view of these circumstances, there has been a demand for a tire-wheel assembly that allows for attaching Helmholtz resonators to commercially sold wheels easily.

An object of the present invention is to provide a tire-wheel assembly that allows for mounting a Helmholtz resonator on a commercial wheel easily.

An aspect of the present invention is a tire-wheel assembly including: a wheel having a pair of bead seats and a well portion; a tire having a pair of tire beads seated on the pair of bead seats; a lid body having two edge portions located opposite each other in a wheel width direction; and a sub-air chamber member disposed on the lid body. Each of the two edge portions is sandwiched between corresponding one of the pair of bead seats and corresponding one of the pair of tire beads so that the lid body is arranged above the well portion.

Another aspect of the present invention is a tire-wheel assembly including: a wheel having a pair of bead seats and a well portion; a tire having a pair of tire beads seated on the pair of bead seats; and a lid body having two edge portions located opposite each other in a wheel width direction. Each of the two edge portions of the lid body is sandwiched between corresponding one of the pair of bead seats and corresponding one of the pair of tire beads so that the lid body is arranged above the well portion. The lid body and an outer circumferential surface of the well portion together define a sub-air chamber between the lid body and the outer circumferential surface.

According to the present invention, it is possible to provide a tire-wheel assembly that allows for mounting a Helmholtz resonator on a commercial wheel easily.

### BRIEF DESCRIPTION OF THE DRAWINGS

FIG. 1 is a perspective view of a tire-wheel assembly according to an embodiment of the present invention.

FIG. 2 is a cross-sectional view taken along line II-II in FIG. 1.

FIG. 3 is a perspective view of a tire-wheel assembly according to another embodiment of the present invention.

FIG. 4 is a cross-sectional view taken along line IV-IV in FIG. 3.

### DETAILED DESCRIPTION OF THE EMBODIMENTS

Hereinafter, a tire-wheel assembly according to an embodiment of the present invention is described in detail with reference to the drawings as needed. In the drawings to be referred to, “X” indicates a wheel circumferential direction, “Y” indicates a wheel width direction, and “Z” indicates a wheel radial direction. Herein, the term “outer”, when used in conjunction with “in the wheel width direction”, means a position that is farther in the wheel width direction from a wheel width direction center. Likewise, the term “outermost”, when used in conjunction with “in the wheel width direction”, means a position that is farthest in the wheel width direction from a wheel width direction center.

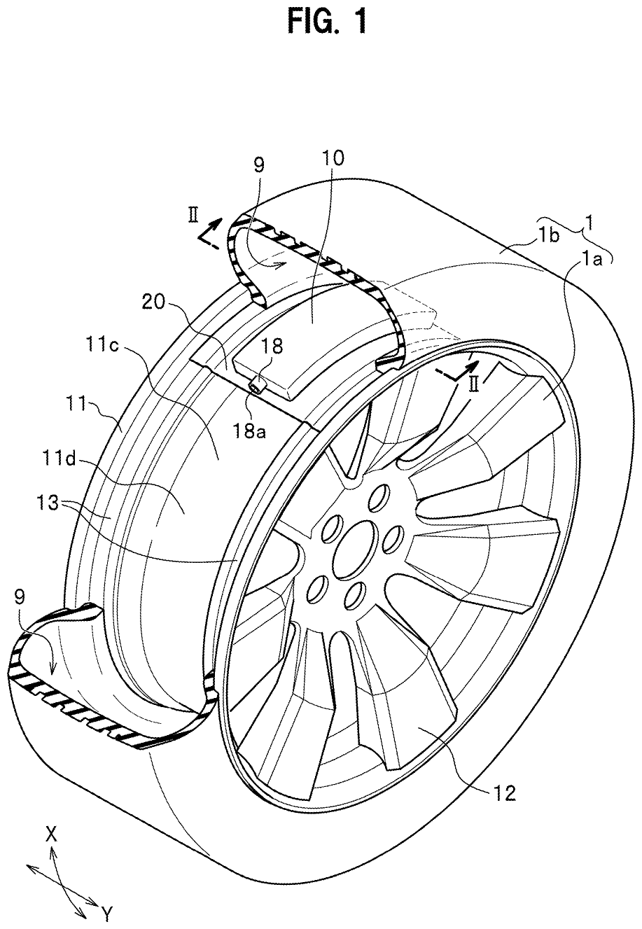

FIG. 1 is a perspective view of a tire-wheel assembly 1 according to an embodiment of the present invention.

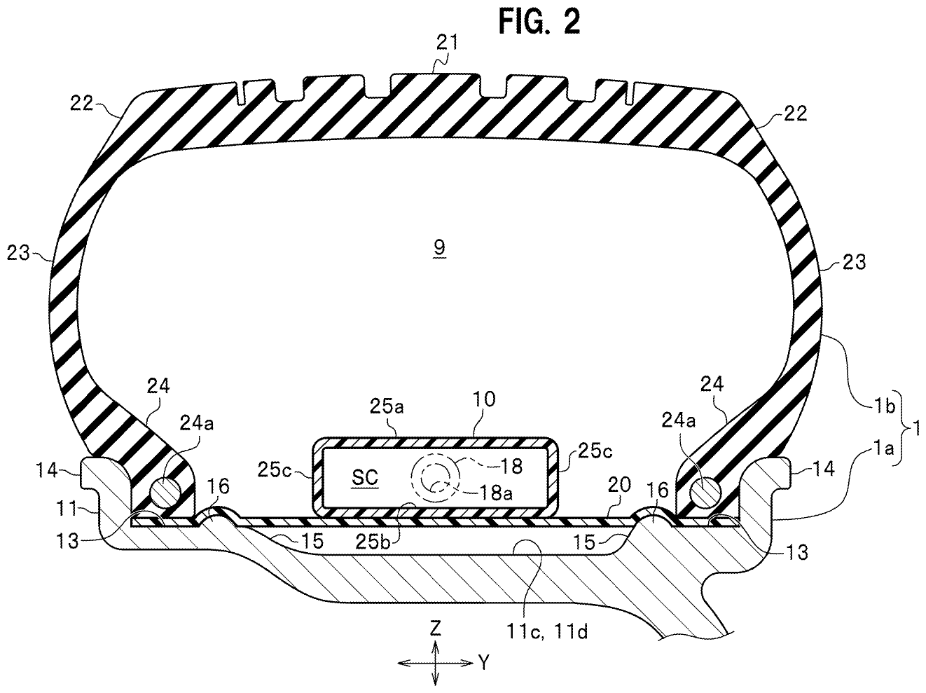

FIG. 2 is a cross-sectional view taken along line II-II in FIG. 1.

As shown in FIG. 1, the tire-wheel assembly 1 according to the present embodiment has a wheel 1a and a tire 1b as major constituent elements.

The wheel 1a according to the present embodiment is made of a light alloy, such as an aluminum alloy or a magnesium alloy.

The wheel 1a includes a rim 11 on which to mount the tire 1b, and a disc 12 coupling the rim 11 to a hub not shown.

The rim 11 has two end portions that are opposite to each other in the wheel width direction Y, at each of which a bead seat 13 is formed, and has a well portion 11c recessed inward in the wheel radial direction (toward the center of rotation) between the bead seats 13. A bottom surface of this recess defines an outer circumferential surface 11d of the well portion 11c, which has a substantially constant diameter about the wheel axis along the wheel width direction Y.

As shown in FIG. 2, the rim 11 includes a pair of vertical walls 15 that rise toward rim flanges 14 of the rim 11 respectively from two end portions of the outer circumferential surface 11d of the well portion 11c that are located opposite each other in the wheel width direction Y. Each of the bead seats 13 of the rim 11 is located on an outer side of the corresponding vertical wall 15 in the wheel width direction Y with a hump 16 in between. Each of the rim flanges 14 continuously rises from an end of the corresponding bead seat 13 that is located outermost in the wheel width direction Y.

As shown in FIG. 1, the tire 1b extends around the rim 11 in a toroidal shape to form a tire air chamber 9 inside the tire 1b.

As shown in FIG. 2, the tire 1b includes a tread 21 defining a ground contact surface, side walls 23 defining side surfaces of the tire 1b with shoulders 22 connecting the side walls 23 and the tread 21, and tire beads 24 seated on the bead seats 13.

Bead wire 24a is arranged in each tire bead 24. This bead wire 24a extends circularly in a circumferential direction of the rim 11. The bead wire 24a causes the tire bead 24 to be seated on the bead seat 13 by the tightening force of the bead wire 24a.

As shown in FIG. 1, the tire-wheel assembly 1 of the present embodiment further includes a lid body 20 arranged on the outer circumferential surface 11d of the well portion 11c and a sub-air chamber member 10 (Helmholtz resonator) provided on the lid body 20.

The lid body 20 is curved along the wheel circumferential direction X.

There is no particular limit to the material of which the lid body 20 is made so long as the material has a predetermined rigidity. The lid body 20 may be, for example, a resin plate, a metal plate, or the like.

As shown in FIG. 2, the lid body 20 has two end portions located opposite each other in the wheel width direction Y, and each of the two end portions is sandwiched between the corresponding bead seat 13 and the corresponding tire bead 24.

More specifically, the lid body 20 has a portion located above the well portion 11c and located lower than (on a wheel radial direction inner side of) the tops of the humps 16. The lid body 20 of the present embodiment extends outward from a center portion thereof located central relative to a length of the lid body 20 in the wheel width direction Y in parallel with a wheel axis, and extends on the humps 16 and the bead seats 13 following the shape of the peripheral surfaces of the humps 16 and the bead seats 13.

Incidentally, in the case of the lid body 20 according to the present embodiment, an adhesive may be applied between the lid body 20 and the bead seats 13 and/or between the lid body 20 and the tire beads 24.

As shown in FIG. 1, the sub-air chamber member 10 (Helmholtz resonator) is disposed on an upper surface (wheel radial direction outer side surface) of the lid body 20. This sub-air chamber member 10 includes a box body with a hollow space. The sub-air chamber member 10 of the present embodiment is a resin molded product made of polypropylene, polyamide, or the like.

As shown in FIG. 2, the sub-air chamber member 10 includes a bottom plate 25b disposed on the side of the lid body 20, an upper plate 25a located opposite the bottom plate 25b, and a pair of side plates 25c that connect between the bottom plate 25b and the upper plate 25a. The hollow space surrounded and formed by these upper plate 25a, bottom plate 25b, and side plates 25c functions as a sub-air chamber SC.

As shown in FIG. 1, the sub-air chamber member 10 is elongated in the wheel circumferential direction X, curved along the lid body 20, and connected with the lid body 20. Examples of the method for connecting the sub-air chamber member 10 to the lid body 20 include adhesive bonding, welding and the like.

The sub-air chamber member 10 includes a tube body 18 at an end of the sub-air chamber member 10 that is farthest in the wheel circumferential direction X. The tube body 18 has a communication hole 18a defined therein. The sub-air chamber SC and the tire air chamber 9 communicate with each other via the communication hole 18a.

Although not shown, according to the present embodiment, four sub-air chamber members 10 are arranged in the wheel circumferential direction X. The sub-air chambers SC each having the tube body 18 defining the communication hole 18a therein are disposed in such a way that the tube bodies 18 are located at substantially 90-degree intervals about the wheel rotation axis. However, the number of the sub-air chambers SC and the positions of the tube bodies 18 are not limited thereto. When the number of the sub-air chambers SC is two, the respective tube bodies 18 can be arranged at positions spaced at 180-degree intervals about the wheel rotation axis. When the number of the sub-air chambers SC is three or five or more, the tube bodies 18 can be arranged at regular intervals in the wheel circumferential direction X.

The sub-air chamber member 10 is attached to the wheel 1a by, while placing the two ends of the lid body 20 on the bead seats 13 of the wheel 1a, setting the tire beads 24 of the tire 1b onto the bead seats 13 in accordance with a general tire assembling method.

### OPERATIONS AND ADVANTAGEOUS EFFECTS

Next, a description will be given of the operations and advantageous effects that can be achieved by the tire-wheel assembly 1 of the present embodiment.

According to the tire-wheel assembly 1 of the present embodiment, the sub-air chamber member 10 is supported by the tire-wheel assembly 1 via the lid body 20 having the two end portions sandwiched between the tire beads 24 and the bead seats 13.

With this structure of the tire-wheel assembly 1, it is possible to mount the sub-air chamber member 10 by setting the tire beads 24 on the bead seats 13 of the wheel 1a. That is, the structure of the tire-wheel assembly 1 eliminates the need of forming vertical walls on the wheel 1a to mount the sub-air chamber member 10 thereon like conventional wheels (e.g., see Japanese Patent Application Publication No. 2012-45971). Thus, with the structure of this tire-wheel assembly 1, it is possible to mount the sub-air chamber member 10 on a commercially sold wheel 1a easily.

According to the structure of the tire-wheel assembly 1 of the present embodiment, the portion of the lid body 20 that is located above the well portion 11c is located lower than the tops of the humps 16. With this structure of the tire-wheel assembly 1, the sub-air chamber member 10 is located at a position inward in the wheel radial direction Z in the tire air chamber 9. This structure of the tire-wheel assembly 1 can reduce the interference of the tire beads 24 on the sub-air chamber member 10 that may possibly occur during the setting of the tire beads 24 on the bead seats 13.

Although an embodiment of the present invention has been described, the present invention is not limited to the embodiment described above and can be carried out in various modes.

According to the above embodiment, the sub-air chamber member 10 is attached to the upper surface of the lid body 20. However, the tire-wheel assembly 1 can be configured such that the sub-air chamber member 10 may be attached to a lower surface of the lid body 20.

In addition, according to the present invention, the sub-air chamber member 10 may be omitted by forming a sub-air chamber between the lid body 20 and the outer circumferential surface 11d of the well portion 11c.

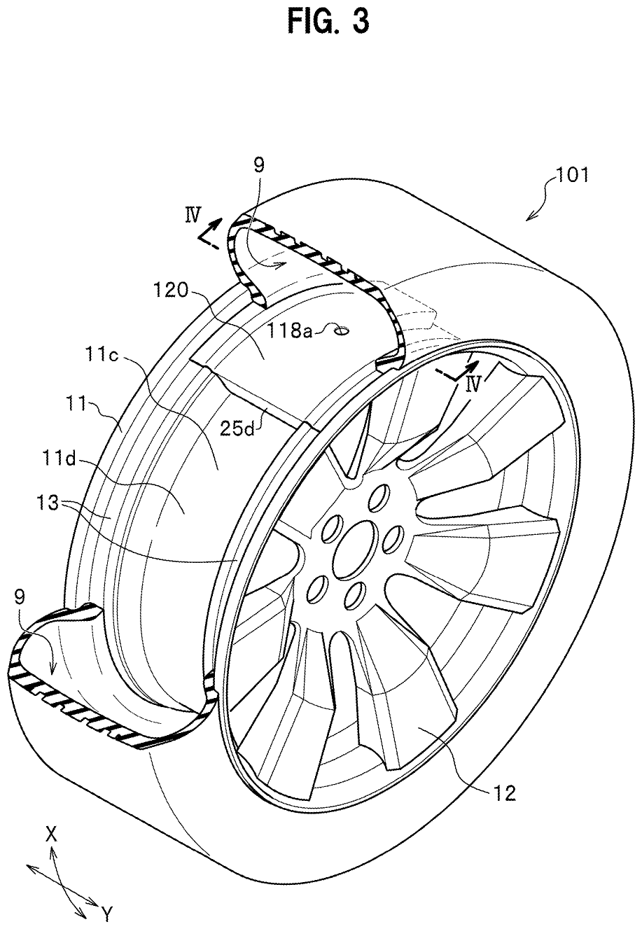

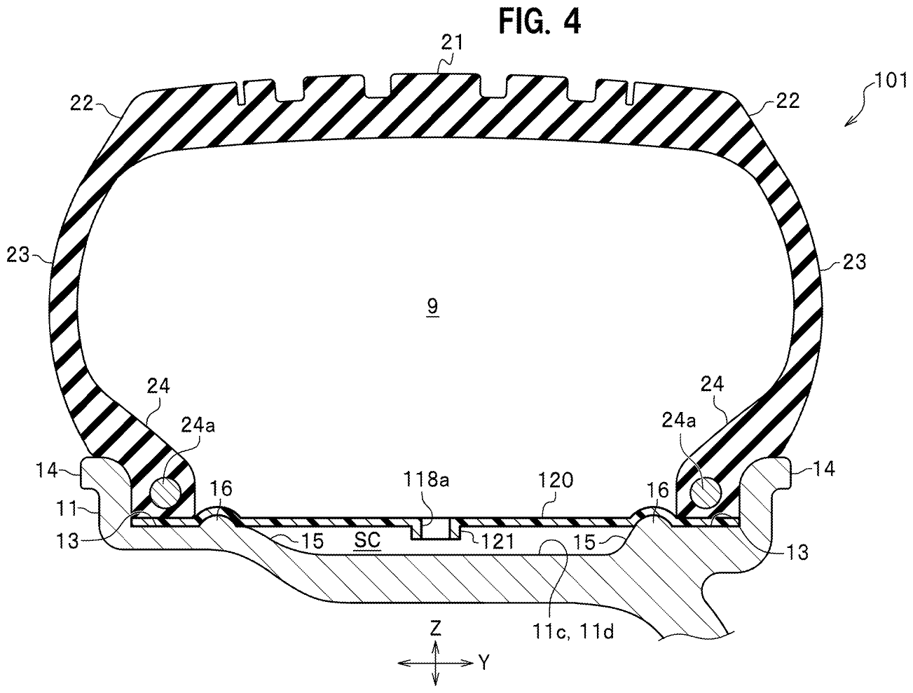

FIG. 3 is a perspective view of a tire-wheel assembly 101 according to another embodiment (modification). FIG. 4 is a cross-sectional view taken along line IV-IV in FIG. 3. In FIGS. 3 and 4, the same constituents as those of the above embodiment are denoted with the same reference signs, and their detailed descriptions are omitted.

As shown in FIG. 3, the tire-wheel assembly 101 according to the modification has a lid body 120 with two vertical plates 25d respectively formed on two ends of the lid body 120 that are located opposite each other in the wheel circumferential direction X. The two vertical plates 25d seal the space between the lid body 120 and the well portion 11c. Note that, in FIG. 3, only one of the two vertical plates 25d is illustrated and illustration of the other one is omitted for convenience of drawing.

The lid body 120 has a communication hole 118a located substantially centrally with respect to the length of the lid body 120 in the wheel circumferential direction X and the length of the lid body 120 in the wheel width direction Y.

This lid body 120 has the same configuration as the lid body 20 (see FIG. 2) of the above embodiment except that the sub-air chamber member 10 (see FIG. 2) on the lid body 20 is eliminated and the lid body 120 is provided with the vertical plates 25d and the communication hole 118a.

As shown in FIG. 4, the lid body 120 and the well portion 11c together define a sub-air chamber SC therebetween. The sub-air chamber SC and the tire air chamber 9 communicate with each other via the communication hole 118a.

In FIG. 4, the reference sign 121 indicates a circular cylindrical collar member defining the communication hole 118a. The collar member 121 is configured to have a height such that the result of adding the value of the height of the collar member to the value of the thickness of the lid body 120 corresponds to the designed length of the communication hole 118a.

With the above-described tire-wheel assembly 101, it is possible to eliminate the sub-air chamber member 10 while achieving the same operations and advantageous effects as those achieved by the tire-wheel assembly 1 of the above embodiment. Thus, the tire-wheel assembly 101 can be reduced in weight and production cost. In addition, the structure of the tire-wheel assembly 101 can more reliably reduce the interference of the tire beads 24 on a sub-air chamber member 10 that may possibly occur during the setting of the tire beads 24 on the bead seats 13.

What is claimed is:

1. A tire-wheel assembly, comprising:
a wheel having a pair of bead seats and a well portion;
a tire having a pair of tire beads seated on the pair of bead seats;
a lid body having two edge portions located opposite each other in a wheel width direction, wherein each of the two edge portions is sandwiched between corresponding one of the pair of bead seats and corresponding one of the pair of tire beads so that the lid body is arranged above the well portion; and
a sub-air chamber member disposed on the lid body.

2. A tire-wheel assembly, comprising:
a wheel having a pair of bead seats and a well portion;
a tire having a pair of tire beads seated on the pair of bead seats; and
a lid body having two edge portions located opposite each other in a wheel width direction,
wherein each of the two edge portions of the lid body is sandwiched between corresponding one of the pair of bead seats and corresponding one of the pair of tire beads so that the lid body is arranged above the well portion, and
wherein the lid body and an outer circumferential surface of the well portion together define a sub-air chamber between the lid body and the outer circumferential surface.

3. The tire-wheel assembly according to claim 1,
wherein the lid body has a portion located directly above the well portion and located lower than a hump of the wheel.

4. The tire-wheel assembly according to claim 2,
wherein the lid body has a portion located directly above the well portion and located lower than a hump of the wheel.
